(19) United States
(12) Patent Application Publication
(10) Pub. No.: US 2014/0108405 A1
(43) Pub. Date: Apr. 17, 2014

(54) USER-SPECIFIED IMAGE GROUPING SYSTEMS AND METHODS

(71) Applicant: RealNetworks, Inc., Seattle, WA (US)

(72) Inventors: Kadir RATHNAVELU, Bellevue, WA (US); Alec MUZZY, Woodinville, WA (US); Christine MCKEE, Seattle, WA (US)

(21) Appl. No.: 13/653,236

(22) Filed: Oct. 16, 2012

(51) Int. Cl. G06F 17/30

(52) U.S. Cl. CPC G06F 17/3028
USPC 707/737

(57) ABSTRACT

Digital images may be filtered according to a first user-selectable filtering metadata dimension. The filtered digital images may also be grouped according to a second user-selectable pivoting metadata dimension. A group of the filtered digital images may additionally be selected and focused on. The focused group of filtered digital images may be further filtered and grouped according to further user-selectable metadata dimensions.

### BACKGROUND

Since 2002, digital cameras have outsold film cameras. In more recent years, smart phones have been integrated with increasingly capable cameras, and millions of people regularly share digital photos via the World Wide Web.

As digital photograph y has become ubiquitous, more and more people have developed a need to organize and curate their personal digital image collections. Consequently, many software applications for organizing and curating digital-images have been developed. Such software applications typically allow a user to select groups of digital images according to some criterion.

For example, the user may be able to select subsets of digital images that were taken during a certain period of time or at a certain place, that depict certain people, that the user has tagged as being associated with a certain event, or the like.

However, existing software applications do not allow the user to perform further automatic grouping or selection operations on a selected subset of digital images.

### BRIEF DESCRIPTION OF THE DRAWINGS

FIG. 1 illustrates a system in accordance with one embodiment.

FIG. 2 illustrates several components of an exemplary client device in accordance with one embodiment.

FIG. 3 illustrates a routine for filtering and grouping digital images, such as may be performed by a client device in accordance with one embodiment.

FIG. 4 illustrates a subroutine for grouping a filtered subset of digital images according to a given pivot indication, such as may be performed by a client device in accordance with one embodiment.

FIG. 5 illustrates a subroutine for capturing a new digital image, such as may be performed by a client device in accordance with one embodiment.

FIG. 6 illustrates a multiplicity of digital images displayed on a client device, in accordance with one embodiment.

FIG. 7 illustrates a filtered subset of a multiplicity of digital images displayed on a client device, in accordance with one embodiment.

FIG. 8 illustrates a plurality of grouped image collections displayed on a client device, in accordance with one embodiment.

FIG. 9 illustrates a plurality of digital images, displayed on a client device, that are associated with an indicated location and date, in accordance with one embodiment.

### DESCRIPTION

In various embodiments, as described further herein digital images may be filtered according to a first user-selectable filtering metadata dimension. The filtered digital images may also be grouped according to a second user-selectable pivoting metadata dimension. A group of the filtered digital images may additionally be selected and focused on. The focused group of filtered digital images may be further filtered and grouped according to further user-selectable metadata dimensions.

As the term is used herein, “filter”, “filtered”, “filtering”, and the like are used to refer to a process of selecting from a set of digital images a smaller subset that includes only those digital images that match a certain criterion based on metadata associated with the digital images. For example, as the term is used herein, a set of digital images may be “filtered” to obtain a subset of only those digital images that are associated with a given date or dates, with a given person or people, with a given event or events, or with some other similar dimension of metadata.

The term “filter” (and variants thereof) is not used herein in its signal-processing or digital-image-processing sense. In other words, the term “filter” (and variants thereof) does not refer herein to a device or process that removes from an image some unwanted component or feature, such as to blur, sharpen, color-correct, enhance, restore, compress, or otherwise process an image as if it were a two-dimensional signal.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

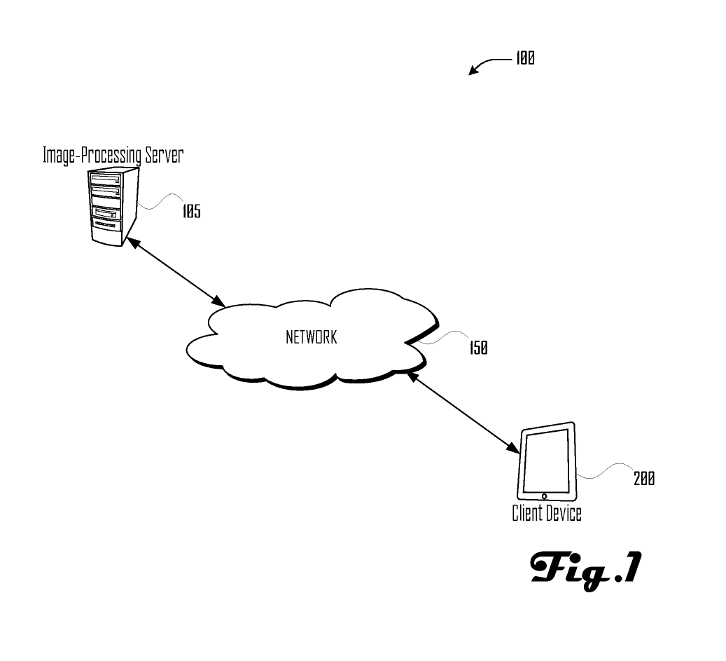

FIG. 1 illustrates a system in accordance with one embodiment. Image-processing server 105 and client device 200 are connected to network 150.

In various embodiments, image-processing server 105 may comprise one or more physical and/or logical devices that collectively provide the functionalities described herein. In some embodiments, image-processing server 105 may comprise one or more replicated and/or distributed physical or logical devices. In some embodiments, image-processing server 105 may comprise one or more computing resources provisioned from a “cloud computing” provider.

In various embodiments, network 150 may include the Internet, a local area network (“LAN”), a wide area network (“WAN”), a cellular data network, and/or other data network.

In various embodiments, client device 200 may include desktop PC, mobile phone, laptop, tablet, or other computing device that is capable of connecting to network 150 and displaying digital images as described herein.

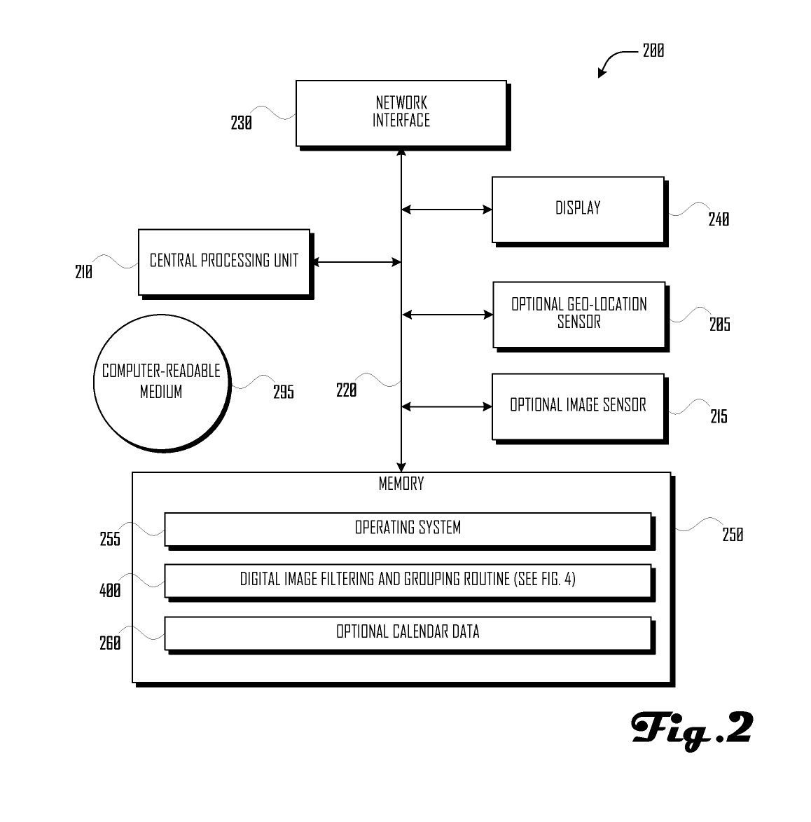

FIG. 2 illustrates several components of an exemplary client device in accordance with one embodiment. In some embodiments, client device 200 may include many more components than those shown in FIG. 2. However, it is not necessary that all of these generally conventional components be shown in order to disclose an illustrative embodiment.

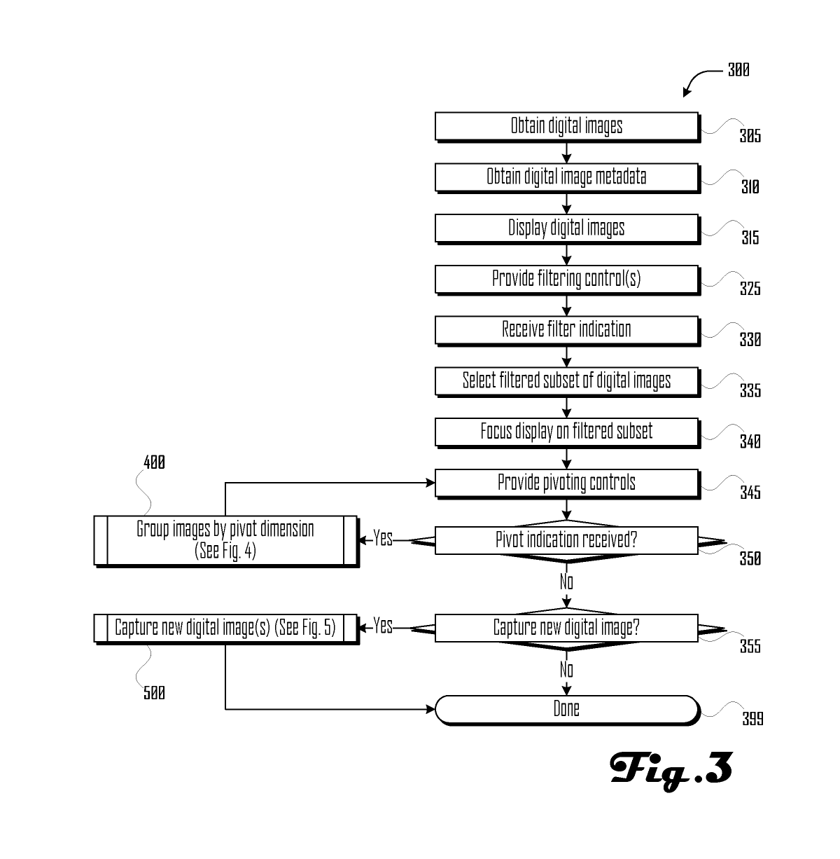

Client device 200 also includes a processing unit 210, a memory 250, and a display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for a routine 300 for filtering and grouping digital images (see FIG. 3, discussed below). In addition, the memory 250 also stores an operating system 255 and optionally, calendar data 260, which in some embodiments may be a local copy of calendar data that client device 200 periodically synchronizes with a remote calendar service.

These and other software components may be loaded into memory 250 of client device 200 using a drive mechanism (not shown) associated with a non-transient computer readable storage medium 295, such as a floppy disc, tape, DVD/CD-ROM drive, memory card, or the like. In some embodiments, software components may alternately be loaded via the network interface 230, rather than via a non-transient computer readable storage medium 295.

In some embodiments, client device 200 includes one or both of a geo-location sensor 205 (e.g., a Global Positioning System (“GPS”) receiver, a Wi-Fi-based positioning system (“WPS”), a hybrid positioning system, or the like) and a digital-image sensor 215 (e.g. a Complementary metal-oxide-semiconductor (“CMOS”) image sensor, a charge-coupled device (“CCD”) image sensor, or the like).

FIG. 3 illustrates a routine 300 for filtering and grouping digital images, such as may be performed by a client device 200 in accordance with one embodiment. In block 305, routine 300 obtains a multiplicity of digital images. For example, in one embodiment, a user may capture the multiplicity of digital images via an image capture device associated with client device 200. In other embodiments, routine 300 may obtain the multiplicity of digital images from a remote server (e.g. image-processing server 105).

In block 310, routine 300 obtains digital-image metadata. For example, in one embodiment, routine 300 may obtain digital-image metadata from a remote server (e.g. image-processing server 105). In various embodiments, digital-image metadata may include metadata such as some or all of the following:
location metadata indicating a geographic location associated with each digital image;
event metadata indicating an event associated with each digital image;
person metadata indicating a person associated with each digital image;
time metadata indicating a date and/or time associated with each digital image; and
social metadata indicating a social relationship associated with each digital image.

In various embodiments, routine 300 may obtain digital-image metadata including values such as some or all of the following:

```
{ “id”: 1,
  “result”: {
    “33466”: {
      “flash”: false,
      “type”: “p”,
      “serviceName”: “facebook”,
      “id”: “33466”,
      “dateTaken”: “2012-08-07T00:00:00.000Z”,
      “name”: “332271930198865.jpg”,
      “lat”: 47.6146503,
      “peopleIDs”: [12345, 23456],
      “lon”: −122.3530623,
      “lastUpdated”: “2012-09-12T21:09:01.979Z”,
      “url”: “https://imageserver.s3.amazonaws.com/233/1...” } } }
```

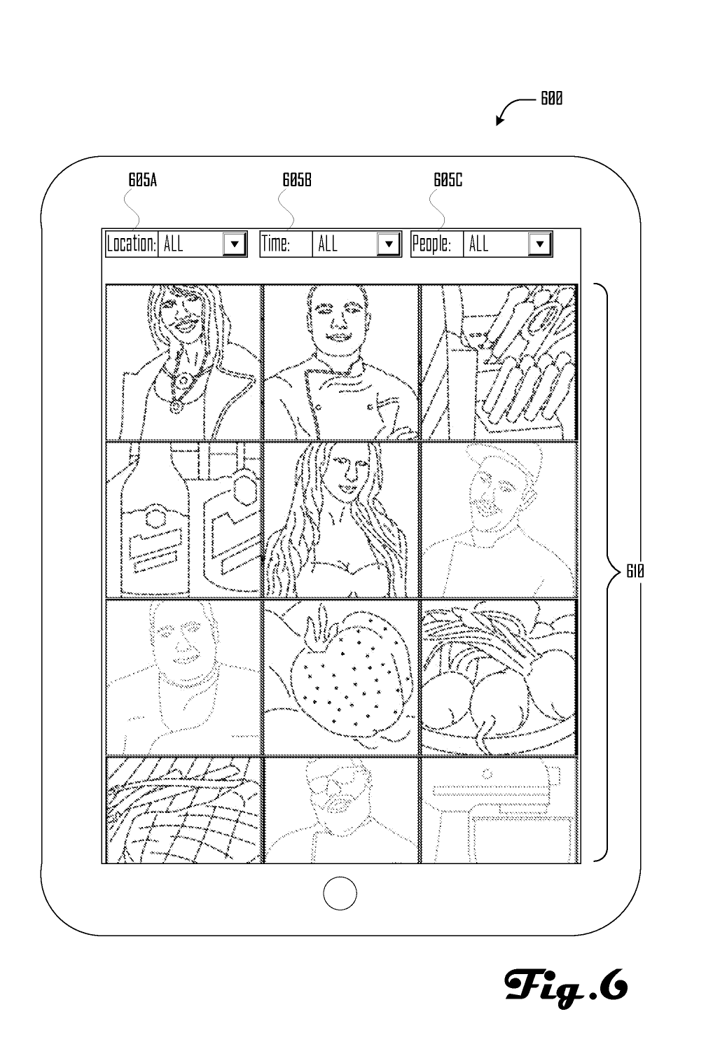

In block 315, routine 300 displays (e.g., on client device 200) a multiplicity of digital images obtained in block 305. See, e.g., FIG. 6, below.

In block 325, routine 300 displays (e.g., on client device 200) one or more user-actionable filtering controls, each being associated with a metadata dimension. See, e.g., filtering controls 605A-C of FIG. 6, discussed below. For example, in one embodiment, a filtering control associated with a location metadata dimension may allow a user to select from a list of locations that are associated with one or more of the multiplicity of digital images. For example, if some digital images of the multiplicity of digital images were taken in Seattle and other digital images were taken in San Francisco, the filtering control may allow the user to select among options such as ‘Seattle’, ‘San Francisco’, or ‘All locations’. Similarly, if some digital images of the multiplicity of digital images were taken by or depict John Smith and other digital images were taken by or depict Mary Jones, a filtering control may allow the user to select among options such as ‘John Smith’, ‘Mary Jones’, or ‘All people’.

In other embodiments, filtering controls may allow a user to select among different time frames (e.g., to focus on digital images taken on different days, in different months, years, or the like); among different events (e.g., to focus on digital images taken at, depicting, or otherwise associated with events such as parties, conventions, meetings, sporting events, vacations, or the like); and among other such metadata dimensions.

In block 330, routine 300 receives a filter indication via one of the filtering controls provided in block 325. For example, in one embodiment, a user may select a location metadata option such as ‘Seattle’, ‘San Francisco’, or the like; a time metadata option such as ‘this month’, ‘September 2012’, ‘2011’, or the like; a person metadata option such as ‘John Smith’, ‘Mary Jones’, or the like; a social metadata option such as ‘Friends’, ‘Close friends’, ‘Friends of friends’, or the like; or other such metadata option.

In block 335, routine 300 selects from among the multiplicity of digital images a filtered subset of digital images that match a metadata criterion associated with the selected filter indication. For example, if the user selects a location metadata option such as ‘Seattle’, routine 300 may select a filtered subset of digital images that were taken in or are otherwise associated with Seattle. Similarly, if the user selects a time metadata option such as ‘this month’, routine 300 may select a filtered subset of digital images that were taken in or are otherwise associated with the current month.

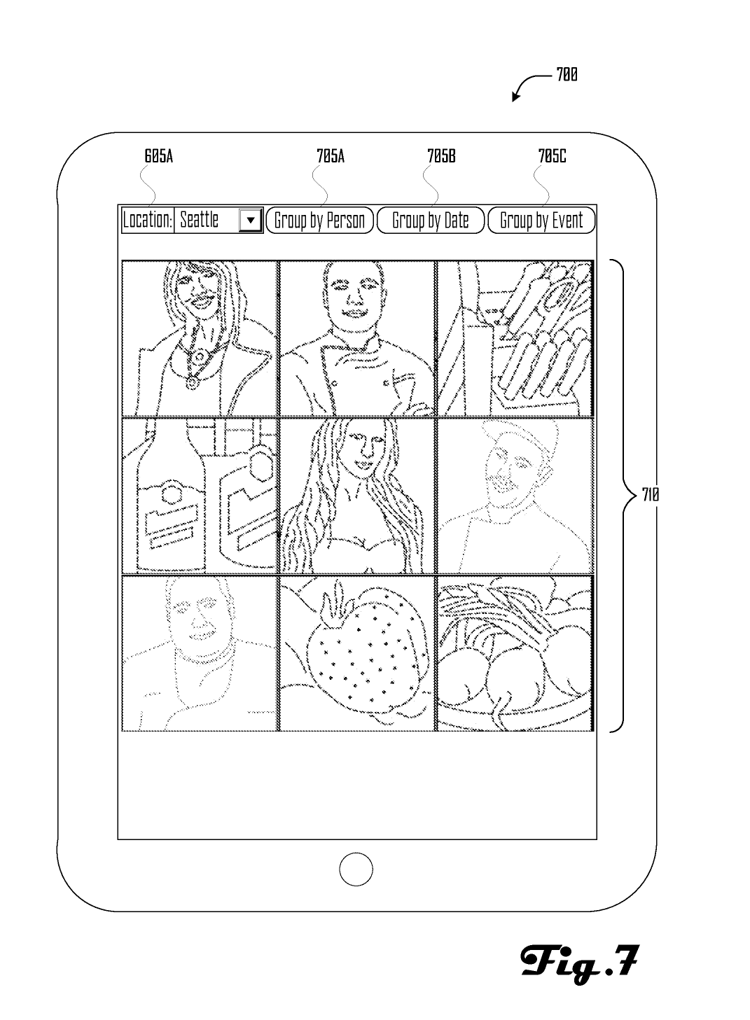

In block 340, routine 300 focuses the image display on the filtered subset of digital images that were selected in block 335. See, e.g., FIG. 7, discussed below.

In block 345, routine 300 displays (e.g., on client device 200) one or more user-actionable pivoting controls, each being associated with a metadata dimension. See, e.g., pivoting controls 705A-C of FIG. 7, discussed below. For example, in one embodiment, a pivoting control associated with a location metadata dimension may allow a user to select from a list of locations that are associated with one or more of the multiplicity of digital images. For example, if some digital images of the multiplicity of digital images were taken in Seattle and other digital images were taken in San Francisco, the pivoting control may allow the user to select among options such as ‘Seattle’, ‘San Francisco’, or ‘All locations’. Similarly, if some digital images of the multiplicity of digital images were taken by or depict John Smith and other digital images were taken by or depict Mary Jones, a pivoting control may allow the user to select among options such as ‘John Smith’, ‘Mary Jones’, or ‘All people’.

In other embodiments, pivoting controls may allow a user to select among different time frames (e.g., to group digital images into collections taken on different days, in different months, years, or the like); among different events (e.g., to group digital images into collections taken at, depicting, or otherwise associated with events such as parties, conventions, meetings, sporting events, vacations, or the like); and among other such metadata dimensions.

In decision block 350, routine 300 determines whether a pivot indication has been received (e.g., via one of the pivoting controls provided in block 345). If so, then routine 300 proceeds to subroutine block 400, discussed below. Otherwise, routine 300 proceeds to decision block 355, discussed below.

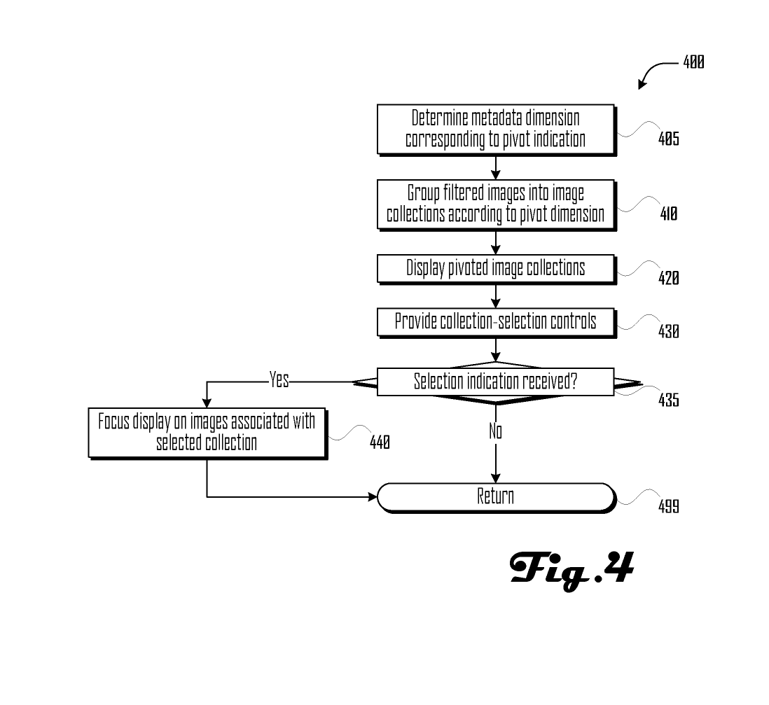

In subroutine block 400, routine 300 calls subroutine 400 (see FIG. 4, discussed below) to group the filtered subset of digital images according to a pivot dimension corresponding to the pivot indication determined to be received in decision block 350.

In decision block 355, routine 300 determines whether a user has indicated a desire to capture a new digital image. For example, in one embodiment, the user may activate a control provided by routine 300, the control activation indicating the user's desire to capture a new digital image. If routine 300 determines that the user has indicated a desire to capture a new digital image, then routine 300 proceeds to subroutine block 500, discussed below. Otherwise, if routine 300 determines that the user has not indicated a desire to capture a new digital image, then routine 300 proceeds to ending block 399.

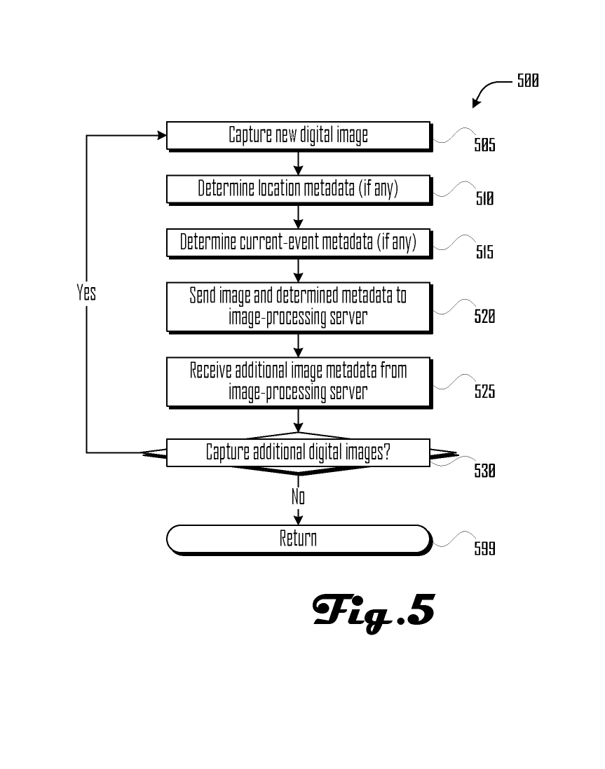

In subroutine block 500, routine 300 calls subroutine 500 (see FIG. 5, discussed below) to capture a new digital image.

Routine 300 ends in ending block 399.

FIG. 4 illustrates a subroutine 400 for grouping a filtered subset of digital images according to the given pivot indication, such as may be performed by a client device 200 in accordance with one embodiment. In block 405, subroutine 400 determines a metadata dimension corresponding to the given pivot indication. In some embodiments, the given pivot indication may be received when a user activates one of the pivoting controls provided in block 345 (see also pivoting controls 705A-C of FIG. 7, discussed below). For example, when a user activates pivot control 705B, subroutine 400 may determine that a location metadata dimension corresponds to the given pivot indication. Similarly, when a user activates one of pivot controls 705A or 705C, subroutine 400 may determine that the given pivot indication corresponds to a person or event metadata dimension, respectively.

In block 410, subroutine 400 groups the filtered subset of digital images into two or more pivoted image collections according to the metadata dimension determined in block 405.

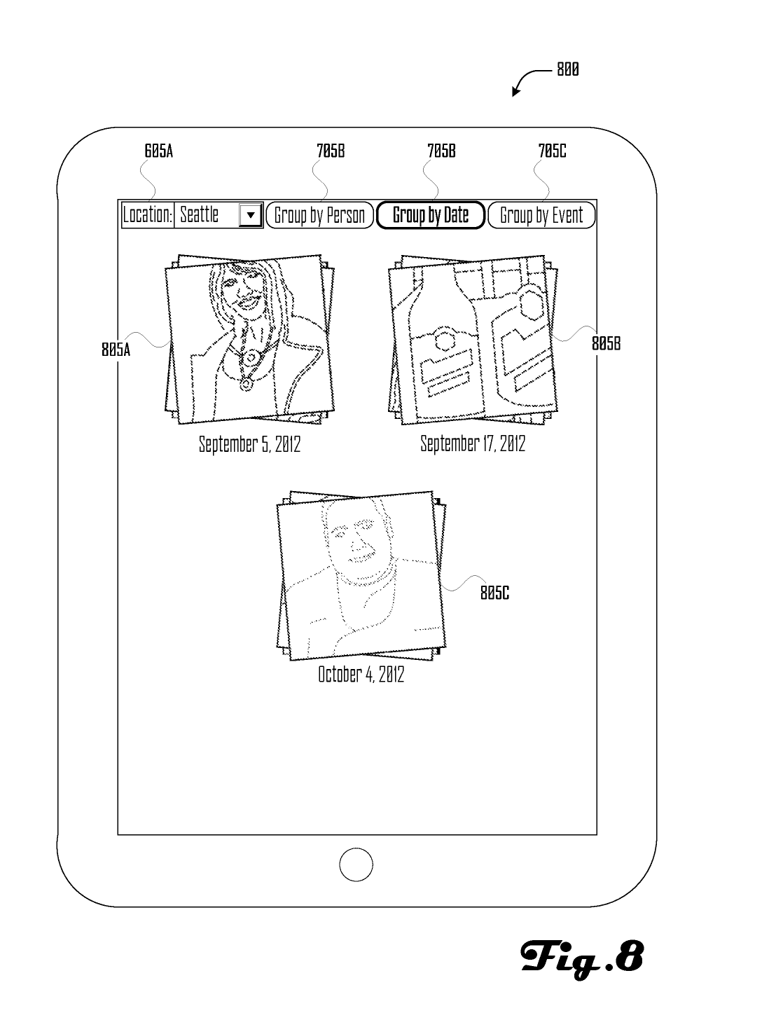

In block 420, subroutine 400 displays the image collections that were grouped in block 410. In some embodiments, the image collections may be depicted as simulated stacks or piles of images. See, e.g., image collections 805A-C of FIG. 8, discussed below.

In block 430, subroutine 400 provides collection-selection controls by which a user may select among the image collections displayed in block 420. In some embodiments, simulated stacks or piles of images may also act as collection-selection controls.

In decision block 435, subroutine 400 determines whether a selection indication has been received, e.g., via a user acting on one of the collection-selection controls provided in block 430. If subroutine 400 determines that the selection indication has been received, then subroutine 400 proceeds to block 440, discussed below. Otherwise, if subroutine 400 determines that a selection indication has not been received, then subroutine 400 proceeds to ending block 499.

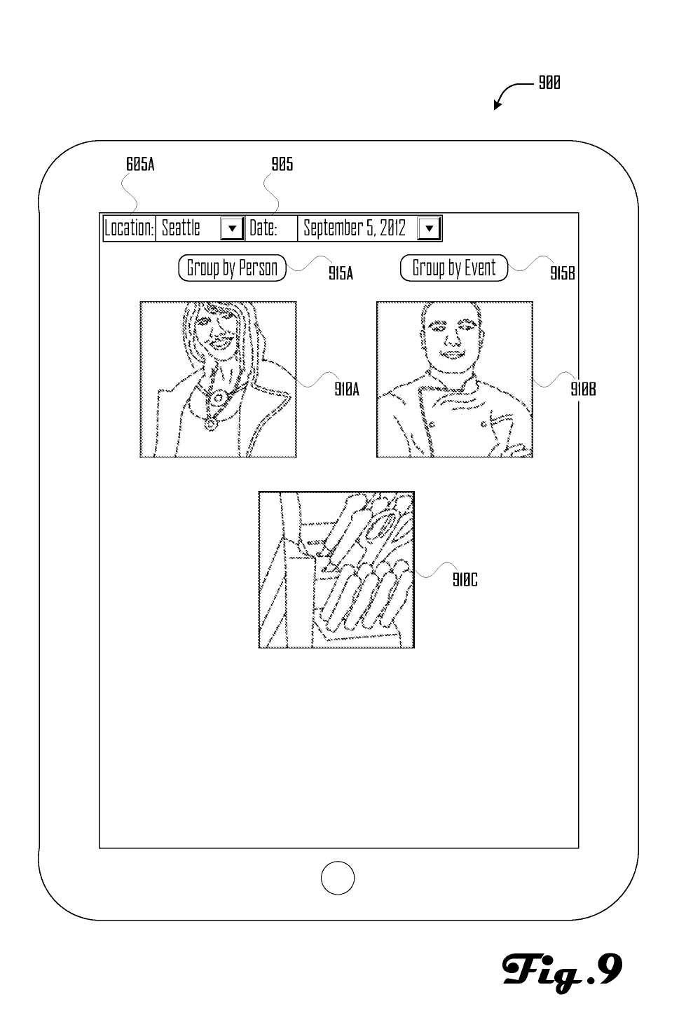

In block 440, subroutine 400 focuses display on digital images associated with an image collection corresponding to the selection indication determined to be received in decision block 435. See, e.g., filtered and focused digital images 910A-C of FIG. 9, discussed below.

Subroutine 400 ends in ending block 499, returning to the caller.

FIG. 5 illustrates a subroutine 500 for capturing a new digital image, such as may be performed by a client device 200 in accordance with one embodiment. In block 505, subroutine 500 captures a new digital image, typically via a camera or other digital-image sensor (e.g. digital-image sensor 215).

In some embodiments, in block 510, subroutine 500 determines current location metadata to be associated with the new digital image captured in block 505. For example, in one embodiment, subroutine 500 may determine geo-location coordinates using a positioning sensor (e.g., geo-location sensor 205).

In some embodiments, in block 515, subroutine 500 determines current-event metadata that may be associated with the new digital image captured in block 505. For example, in one embodiment, subroutine 500 may access calendar data (e.g., calendar data 260) that is associated with client device 200 and that is potentially associated with the new digital image. In some embodiments, subroutine 500 may filter the accessed calendar data to identify calendar items that may be associated with the current date and/or time, and/or the current location metadata determined in block 510.

In block 520, subroutine 500 sends to a remote image-processing server (e.g. image-processing server 105) the new digital image captured in block 505 and any metadata determined in block 510 and/or block 515. In some embodiments, the remote image-processing server may process the new digital image and/or the metadata received therewith in order to associate various additional metadata with the new digital image. For example, in one embodiment, the remote image-processing server may identify persons, events, locations, social relationships, and/or other like entities as being associated with the new digital image.

In block 525, subroutine 500 receives from the remote image-processing server additional metadata (e.g., person, event, time, social, or other like metadata) that the remote image-processing server may have associated with the new digital image. In some embodiments, subroutine 500 may store (at least transiently) the additional metadata to facilitate presenting the new digital image to the user according to methods similar to those described herein.

In decision block 530, subroutine 500 determines whether the user wishes to capture additional new digital images. If so, then subroutine 500 loops back to block 505 to capture an additional new digital image. Otherwise, subroutine 500 proceeds to ending block 599.

Subroutine 500 ends in ending block 599, returning to the caller.

FIG. 6 illustrates a multiplicity of digital images displayed on a client device 200, in accordance with one embodiment. Digital image display 610 displays a multiplicity of digital images.

Filtering controls 605A-C can be acted on by a user to select a filtered subset of the multiplicity of digital images, filtered along a metadata dimension of location (605A), time (605B), or people (605C).

FIG. 7 illustrates a filtered subset of a multiplicity of digital images displayed on a client device 200, in accordance with one embodiment. Filtered digital image display 710 displays the filtered subset of the multiplicity of digital images. In the illustrated embodiment, the user has selected a location metadata dimension (‘Seattle’) using filtering control 605A. Of the twelve digital images displayed in FIG. 6, a subset of nine digital images that are associated with Seattle has been selected, and the display focused on the filtered subset of digital images.

Pivoting controls 705A-C can be acted on by a user to group the filtered subset of the multiplicity of digital images into two or more image collections according to a metadata pivot dimension.

FIG. 8 illustrates a plurality of grouped image collections displayed on a client device 200, in accordance with one embodiment. Image collections 805A-C illustrate three collections of digital images, each grouped together according to a date metadata dimension. More specifically, image collection 805A includes digital images that are associated with the location ‘Seattle’ and that were taken on or are otherwise associated with the date Sep. 5, 2012; image collection 805B includes digital images that are associated with the location ‘Seattle’ and that were taken on or are otherwise associated with the date Sep. 17, 2012; and image collection 805C includes digital images that are associated with the location ‘Seattle’ and that were taken on or are otherwise associated with the date Oct. 4, 2012.

In the illustrated embodiment, image collections 805A-C depict simulated stacks or piles of images. In some embodiments, the depictions may also be user-actionable selection controls allowing a user to select among the image collections.

FIG. 9 illustrates a plurality of digital images, displayed on a client device 200, that are associated with an indicated location and date, in accordance with one embodiment. FIG. 9 includes three filtered and focused digital images 910A-C, each associated with a date metadata dimension (here, Sep. 5, 2012) and a location metadata dimension (here, Seattle).

In the illustrated embodiment, FIG. 9 also includes user-actionable focused grouping controls 915A-B, which may be used to further group the filtered and focused digital images 910A-C according to a third metadata dimension (here, person or event).

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A computer-implemented method for filtering and grouping a multiplicity of digital images, the method comprising:
obtaining, by the computer, metadata associated with the multiplicity of digital images;
displaying, by the computer, the multiplicity of digital images, and providing a user-actionable filtering control associated with a first dimension of said metadata;
in response to a filter indication received via said filtering control, the computer:
selecting a filtered subset of the multiplicity of digital images according to said first dimension of said metadata;
focusing display on said filtered subset of the multiplicity of digital images;
and
providing a plurality of user-actionable pivoting controls; and
in response to a pivot indication received via a selected pivoting control of said plurality of pivoting controls, the computer:
determining a second dimension of said metadata corresponding to said selected pivoting control;
grouping said filtered subset of the multiplicity of digital images into a plurality of image collections according to said second dimension of said metadata;
and
displaying said plurality of image collections.

2. The method of claim 1, further comprising:
providing a plurality of user-actionable collection-selection controls corresponding respectively to said plurality of image collections;
receiving a collection-selection indication via a selected collection-selection control of said plurality of collection-selection controls, said collection-selection indication corresponding to a selected image collection; and
focusing display on digital images associated with said selected image collection.

3. The method of claim 1, wherein said metadata comprises, for each digital image of the multiplicity of digital images, a set of dimensional metadata comprising at least two dimensions selected from a group consisting of:
location metadata indicating a geographic location associated with each digital image;
event metadata indicating an event associated with each digital image;
person metadata indicating a person associated with each digital image;
time metadata indicating a date and/or time associated with each digital image; and
social metadata indicating a social relationship associated with each digital image.

4. The method of claim 3, wherein:
said filtered subset of the multiplicity of digital images is selected according to a first one of said at least two dimensions; and
said plurality of image collections are grouped according to a second one of said at least two dimensions.

5. The method of claim 3, further comprising:
capturing a new digital image and contemporaneously determining current-location metadata associated with the computer;
providing said new digital image and said current-location metadata to a remote image-processing server; and
receiving from said remote image-processing server event or person metadata associated with said new digital image.

6. The method of claim 5, further comprising:
accessing calendar data that is associated with the computer and that is potentially associated with said new digital image; and
providing said calendar data to said remote image-processing server.

7. The method of claim 1, wherein displaying said plurality of image collections comprises animating each digital image of said filtered subset of the multiplicity of digital images into a selected one of a plurality of simulated stacks of digital images, said plurality of simulated stacks corresponding respectively to said plurality of image collections.

8. A computing apparatus comprising a processor and a memory having stored therein instructions that when executed by the processor, configure the apparatus to perform a method for filtering and grouping a multiplicity of digital images, the method comprising:
obtaining metadata associated with the multiplicity of digital images;
displaying the multiplicity of digital images, and providing a user-actionable filtering control associated with a first dimension of said metadata;
in response to a filter indication received via said filtering control:
selecting a filtered subset of the multiplicity of digital images according to said first dimension of said metadata;
focusing display on said filtered subset of the multiplicity of digital images;
and
providing a plurality of user-actionable pivoting controls; and
in response to a pivot indication received via a selected pivoting control of said plurality of pivoting controls:
determining a second dimension of said metadata corresponding to said selected pivoting control;
grouping said filtered subset of the multiplicity of digital images into a plurality of image collections according to said second dimension of said metadata;
and
displaying said plurality of image collections.

9. The apparatus of claim 8, the method further comprising:
providing a plurality of user-actionable collection-selection controls corresponding respectively to said plurality of image collections;
receiving a collection-selection indication via a selected collection-selection control of said plurality of collection-selection controls, said collection-selection indication corresponding to a selected image collection; and
focusing display on digital images associated with said selected image collection.

10. The apparatus of claim 8, wherein said metadata comprises, for each digital image of the multiplicity of digital images, a set of dimensional metadata comprising at least two dimensions selected from a group consisting of:
location metadata indicating a geographic location associated with each digital image;
event metadata indicating an event associated with each digital image;
person metadata indicating a person associated with each digital image;
time metadata indicating a date and/or time associated with each digital image; and
social metadata indicating a social relationship associated with each digital image.

11. The apparatus of claim 10, wherein:
said filtered subset of the multiplicity of digital images is selected according to a first one of said at least two dimensions; and
said plurality of image collections are grouped according to a second one of said at least two dimensions.

12. The apparatus of claim 10, the method further comprising:
capturing a new digital image and contemporaneously determining current-location metadata associated with the computer;
providing said new digital image and said current-location metadata to a remote image-processing server; and
receiving from said remote image-processing server event or person metadata associated with said new digital image.

13. The apparatus of claim 12, the method further comprising:
accessing calendar data that is associated with the computer and that is potentially associated with said new digital image; and
providing said calendar data to said remote image-processing server.

14. The apparatus of claim 8, wherein displaying said plurality of image collections comprises animating each digital image of said filtered subset of the multiplicity of digital images into a selected one of a plurality of simulated stacks of digital images, said plurality of simulated stacks corresponding respectively to said plurality of image collections.

15. A non-transient computer-readable storage medium having stored therein instructions that when executed by a processor, configure the processor to perform a method for filtering and grouping a multiplicity of digital images, the method comprising:
obtaining metadata associated with the multiplicity of digital images;
displaying the multiplicity of digital images, and providing a user-actionable filtering control associated with a first dimension of said metadata;
in response to a filter indication received via said filtering control:
selecting a filtered subset of the multiplicity of digital images according to said first dimension of said metadata;
focusing display on said filtered subset of the multiplicity of digital images;
and
providing a plurality of user-actionable pivoting controls; and
in response to a pivot indication received via a selected pivoting control of said plurality of pivoting controls:
determining a second dimension of said metadata corresponding to said selected pivoting control;
grouping said filtered subset of the multiplicity of digital images into a plurality of image collections according to said second dimension of said metadata;
and
displaying said plurality of image collections.

16. The storage medium of claim 15, the method further comprising:
providing a plurality of user-actionable collection-selection controls corresponding respectively to said plurality of image collections;
receiving a collection-selection indication via a selected collection-selection control of said plurality of collection-selection controls, said collection-selection indication corresponding to a selected image collection; and
focusing display on digital images associated with said selected image collection.

17. The storage medium of claim 15, wherein said metadata comprises, for each digital image of the multiplicity of digital images, a set of dimensional metadata comprising at least two dimensions selected from a group consisting of:
location metadata indicating a geographic location associated with each digital image;
event metadata indicating an event associated with each digital image;
person metadata indicating a person associated with each digital image;
time metadata indicating a date and/or time associated with each digital image; and
social metadata indicating a social relationship associated with each digital image.

18. The storage medium of claim 17, wherein:
said filtered subset of the multiplicity of digital images is selected according to a first one of said at least two dimensions; and
said plurality of image collections are grouped according to a second one of said at least two dimensions.

19. The storage medium of claim 17, the method further comprising:
capturing a new digital image and contemporaneously determining current-location metadata associated with the computer;
providing said new digital image and said current-location metadata to a remote image-processing server; and
receiving from said remote image-processing server event or person metadata associated with said new digital image.

20. The storage medium of claim 19, the method further comprising:
accessing calendar data that is associated with the computer and that is potentially associated with said new digital image; and
providing said calendar data to said remote image-processing server.

21. The storage medium of claim 15, wherein displaying said plurality of image collections comprises animating each digital image of said filtered subset of the multiplicity of digital images into a selected one of a plurality of simulated stacks of digital images, said plurality of simulated stacks corresponding respectively to said plurality of image collections.
